(19) United States
(12) Patent Application Publication
(10) Pub. No.: US 2017/0282099 A1
(43) Pub. Date: Oct. 5, 2017

(54) Free-Fraction Filtration device And Control Method Thereof

(71) Applicant: JUNG HUN PARK, Seongnam (KR)

(72) Inventor: JUNG HUN PARK, Seongnam (KR)

(21) Appl. No.: 15/467,248

(22) Filed: Mar. 23, 2017

(30) Foreign Application Priority Data
Mar. 30, 2016 (KR) 10-2016-0038701

(51) Int. Cl. B01D 29/72; B01D 29/46; B01D 29/66; B01D 29/52

(52) U.S. Cl. CPC B01D 29/72; B01D 29/52; B01D 29/46; B01D 29/66

(57) ABSTRACT

Disclosed are a free-traction filtration device capable of carrying out a massive filtering process and continuous automatic operation, and a method of controlling the same. The free-traction filtration device includes a plurality of filter units each consisting of some sheets of stacked plate filters; top and bottom plates configured to support the filter units at upper and lower portions thereof so as to maintain positions of the filter units, the filter units being circumferentially arranged between the top and bottom plates; a spring configured to resiliently support the top and/or bottom plates in a horizontal state; and an operating unit configured to transmit vibration to the filter units arranged between the top and bottom plates.

### BACKGROUND OF THE INVENTION

Field of the Invention

The present invention relates to a free-fraction filtration device and a control method thereof, and, more particularly, to a free fraction filter capable of carrying out a massive filtering process and continuous automatic operation.

Background of the Related Art

A stacked-disc filtration device consisting of disc filters and a stacked-plate filtration device consisting of plate filters (hereinafter referred to as a stacked-plate filtration device or a free-fraction filtration device) includes a case having an inlet port through which a fluid flows in, and an outlet port through which the fluid flows out, and a filter unit installed in the case. A stacked-plate filter having a ring-shaped structure which can be easily maintained and a filter assembly using the same are disclosed in Korean Patent No. 10-1594876.

The stacked-plate filtration device removes impurities from a fluid by introducing the fluid from the inlet port to the filter unit through a filtering path formed between a plurality of plate filters which are brought into contact with each other to form the filter unit, and the fluid filtered by filtering operation of the filter is discharged outwardly from the case through the outlet port. In the case of filtering the fluid by the stacked-plate filter, an interval between the plates is important. A disc-type plate filter is disclosed in Japanese Patent Laid-Open No. 2011-212620.

The stacked-plate filtration device has an advantage of supplying cleaning water to the outlet port to clean it. The cleaning water to be supplied to the outlet port flows in a direction opposite to the fluid filtering, and thus is discharged from the inlet port through which the fluid flows in. It is referred to as backwash, by which the filter is cleaned by the cleaning water, and floating matters attached to the filter are removed by the cleaning water. However, improvement is needed in the field of the stacked-plate filtration device in view of cleaning efficiency. For example, alien substances caught implanted in the gap between the stacked-plate filters are not easily cleaned by the cleaning water, which prevents the flow of the fluid to deteriorate the filtering efficiency. In order to solve the above problem, the cleaning water is directly and indirectly sprayed to the filter, or there is proposed a device of mechanically shaking off the alien substances by use of a vibrator or the like.

Even though the stacked-plate filtration device employs the backwash method, there are some cases where the filter is not properly cleaned. Also, since the mechanically shaking operation using the vibrator or the like is inconvenient, it is difficult to constantly maintain the filter, and thus some improvements are needed.

### SUMMARY OF THE INVENTION

Therefore, the present invention has been made in view of the above problems of the related art, and an object of the present invention is to provide a free-fraction filtration device capable of carrying out a massive filtering process and continuous automatic operation.

Another object of the present invention is to provide a free-fraction filtration device which can be constantly controlled.

The other object of the present invention is to provide a free-fraction filtration device which can be semi-permanently used.

In order to achieve the above objects, there is provided a free-traction filtration device including: a plurality of filter units each consisting of some sheets of stacked plate filters, in which alien substances caught between the stacked plate filters are removed away from the plate filters by vibration of a vibration plate; a cylindrical case in which the plurality of filter units are installed; top and bottom plates configured to support the filter units at upper and lower portions thereof so as to determine and maintain positions of the filter units, the filter units being circumferentially arranged between the top and bottom plates; a spring configured to resiliently support the top and/or bottom plates in a horizontal state; an operating unit configured to transmit vibration to the filter units arranged between the top and bottom plates; and a vibration plate configured to be resiliently supported by the spring between the top or bottom plate and the operating unit, the top or bottom plate being pressed by the operating unit in the case.

According to the present invention, the top and bottom plates are pressed by the driving unit, and the vibration is interposed between the top or the plate and the driving unit. The spring is interposed between the vibration plate and the top or bottom plate. Therefore, the vibration plate is moved up and down by the operation of the driving unit to constantly remove the alien substances away from the gap between the stacked filter units of the filter unit.

According to the present invention, the vibration plate includes a guide pin protruding from a center thereof, and the guide pin is moved up and down by the top or bottom plate.

The vertical vibrating balance of the top and bottom plates, on which the filter units are circumferentially arranged, is maintained within a specified position.

According to the present invention, the top or bottom plate is resiliently supported by the spring in an inside of the case. Therefore, the vibration transmitted from the top plate is transmitted to a lower space, thereby increasing amplitude of the vibrated filter units and thus improving the effect of removing the alien substances.

According to the present invention, the operating unit includes a driving motor, a shaft extending from the driving motor, and a driving cam installed on the shaft, the vibration plate being into contact with the driving cam. Therefore, the vibration plate is brought into contact with the operating cam at top and bottom dead points to directly transmit the vibration to the filter units.

According to the present invention, the driving motor includes a driving motor, and the driving motor has a control unit which is controlled by measuring a pressure of the fluid. Therefore, since the output of the driving unit is controlled by the fluctuations in pressure, it is possible to control the driving motor, if necessary, and thus to reduce an unnecessary load.

According to the present invention, the control unit has a measuring member having a fluid inflow pressure measuring portion to measure an inflow pressure of the fluid and a case pressure measuring portion to measure an internal pressure of the case; and a controller having a reference value comparing portion to compare the inflow pressure measured by the measuring member and a preset reference value of the pressure and a motor rotation control portion to control rotation of the driving motor, thereby vibrating the filter units according to the fluctuations in pressure.

According to the present invention, if the measured internal pressure P2 of the case is higher than the reference value P of the pressure, the control unit can drive the driving motor.

According to another aspect of the present invention, there is provided a method of controlling a free-fraction filtration device, the method including the steps of: measuring an inflow pressure of a fluid introduced into a case by a measuring member, in which a plurality of filter units are circumferentially arranged in the case; measuring an internal pressure of the case by a measuring member, and comparing the measured values and a reference value of the pressure by a controller of a control unit; and if the internal pressure of the case is higher than the preset reference value of the pressure, operating a driving motor, which rotates a driving cam, to transmit vibration to the filter units through the driving cam, and if the internal pressure of the case is lower than the preset reference value of the pressure, stopping the driving motor to stop operation of the driving cam.

According to the present invention, if the measured internal pressure P2 of the case is lower than the reference value P of the pressure, the method further includes pausing the operation of the driving motor in a standby mode, thereby automatically controlling the unnecessary load.

With the above configuration, the present invention can provide the free fraction filter capable of carrying out a massive filtering process and continuous automatic operation.

Also, the present invention can automatically increase or reduce the vibration against the filter units according to the unusual symptom caused by the blocked filters or the like, thereby decrease in filtration performance of the filter or prepare decrease in efficiency.

In addition, the present invention can provide the free-fraction filtration device which can be semi-permanently used, by preventing the failure, such as blocked filter caused by the alien substances.

Furthermore, it is possible to reduce operation noise, as compared with a mechanical type of the related art which is used to remove the alien substances from the filter units. Also, it is provided the high-reliable free-fraction filtration device by eliminating a manual operation.

### BRIEF DESCRIPTION OF THE DRAWINGS

FIG. 1 is a view schematically illustrating the whole configuration of a free-traction filtration device according to one embodiment of the present invention.

FIG. 2 is a plan view illustrating the free-traction filtration device according to the embodiment of the present invention.

FIG. 3 is a bottom view illustrating the free-traction filtration device according to the embodiment of the present invention.

FIG. 4 is a plan view illustrating arrangement of a filter unit and a base plate in the free-traction filtration device according to the embodiment of the present invention.

FIG. 5 is a view of an example of a filter unit which is applied to the embodiment of the present invention.

FIG. 6 is an enlarged view taken from a circle A in FIG. 5.

FIG. 7 shows a plate filter of the filter unit which is applied to the embodiment of the present invention, of which

FIG. 7A is a view of a disc plate, and FIG. 7B is a view of a star-shaped plate.

FIG. 8 is a block diagram of a control unit according to one embodiment of the present invention.

FIG. 9 is a flow chart illustrating an example of controlling the free-fraction filtration device according to the embodiment of the present invention.

### DETAILED DESCRIPTION OF THE PREFERRED EMBODIMENT

Now, a free-fraction filtration device according to one embodiment of the present invention and a control method thereof will be described in detail with reference to the accompanying drawings.

The term “free-traction filtration device” used herein means a filter capable of freely dividing and removing alien substances contained in a fluid to be filtered through a spaced structure of plate filters. The term “fraction” means division and may mean a process of dividing various components or mixtures into each element or group. However, the above meaning of the fraction is not limited thereto, and may include a filtering process of separating and removing the alien substances contained in the fluid of interest in a broad sense.

The present invention provides a filter unit formed by stacking plate filters, in which a fluid passes through a gap between the plate filters. A wanted gap is formed between the plate filters to secure an interval, and the secured interval is consistently maintained, thereby preventing the alien substances which are larger than the interval from passing the plate filters through a fraction effect.

The free-fraction filtration device according to the present invention can be designed to obtain the same results when the fluid flows in any forward or backward direction, upon backwash.

According to the present invention, a material of the plate filter can be selected from any one of metal or non-metal.

The present invention can remove alien substances by directly transmitting vibration to an inside of a case from an operating unit, as well as properly cleaning the filter.

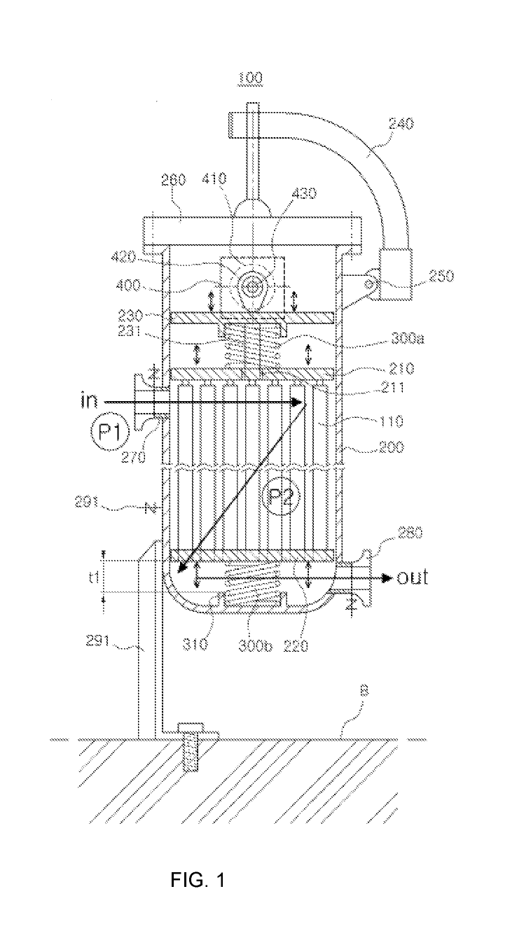

FIG. 1 is a view schematically illustrating the whole configuration of the free-traction filtration device according to one embodiment of the present invention.

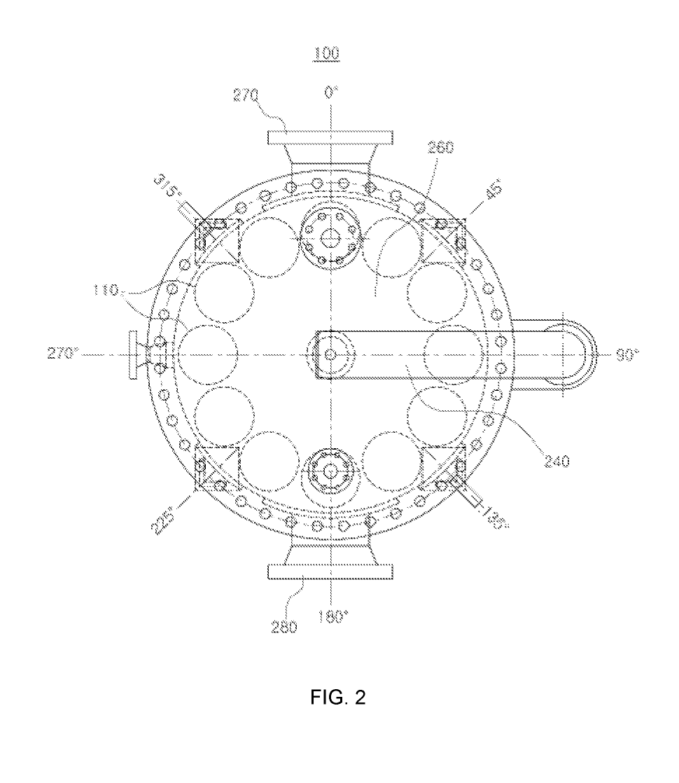

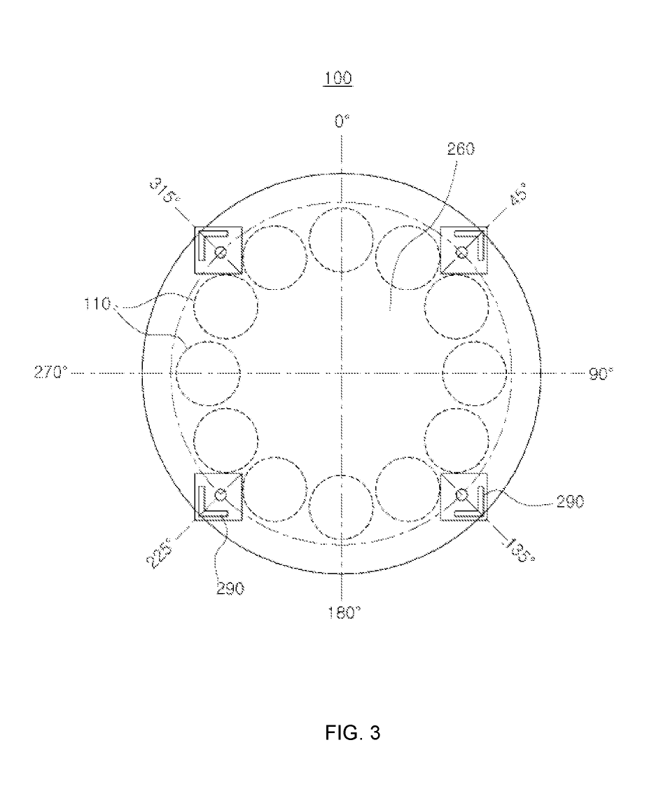

FIG. 2 is a plan view illustrating the free-traction filtration device according to the embodiment of the present invention. FIG. 3 is a bottom view illustrating the free-traction filtration device according to the embodiment of the present invention.

As illustrated in FIGS. 1 to 3, a free-traction filtration device 100 according to the present invention includes a plurality of filter units 110 each consisting of some sheets of stacked plate filters 111, and a case 200 housing the filter units 110 circumferentially arranged therein, thereby carrying out a massive filtering process and continuous automatic operation.

The case 200 has an opened upper portion and a closed lower portion, and the upper portion is closed by a cover 260. The cover 260 is movable by a lifting lug 240 to close or open the upper portion, and the lifting lug 240 is supported by a hinge 250. The case 200 is provided with an inlet port 270 through which the fluid flows in, and an outlet port 280 through which the filtered fluid flows out.

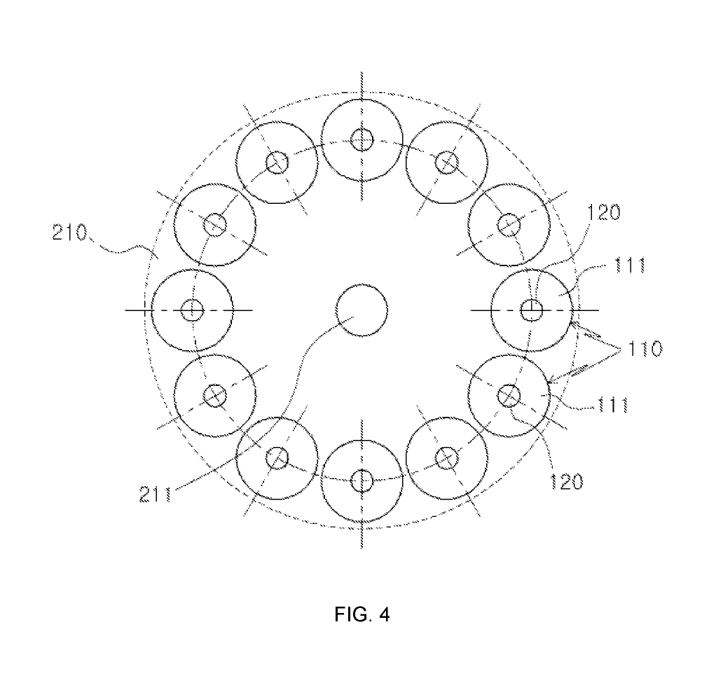

The plate filters 111 forming the filter unit 110 are stacked in a vertical direction in the case 200, and the filter unit 110 is positioned by both base plates 210 and 220 which are located at upper and lower portions, as illustrated in FIG. 4. The fluid introducing through the inlet port 270 passes through the multiple filter units to remove the alien substances contained in the fluid, and then is discharged outwardly from the case 200 through the outlet port 280.

The filter units 110 are circumstantially arranged in the case by the base plates 210 and 220, and the base plates 210 and 220 installed at the upper and lower portions are resiliently supported in a horizontal level by springs 300a and 300b so that all base plates can be moved up and down in the case 200.

The springs 300a and 300b each provided on and below the filter units 110 in the case 200 transmits vibration caused by a driving cam 420 of the operating unit 400 to the filter units 110, as well as reducing operating noise.

The free-fraction filtration device of the present invention includes the operating unit 400 to transmit impact or vibration to the filter units 110 arranged on the base plates 210 and 220.

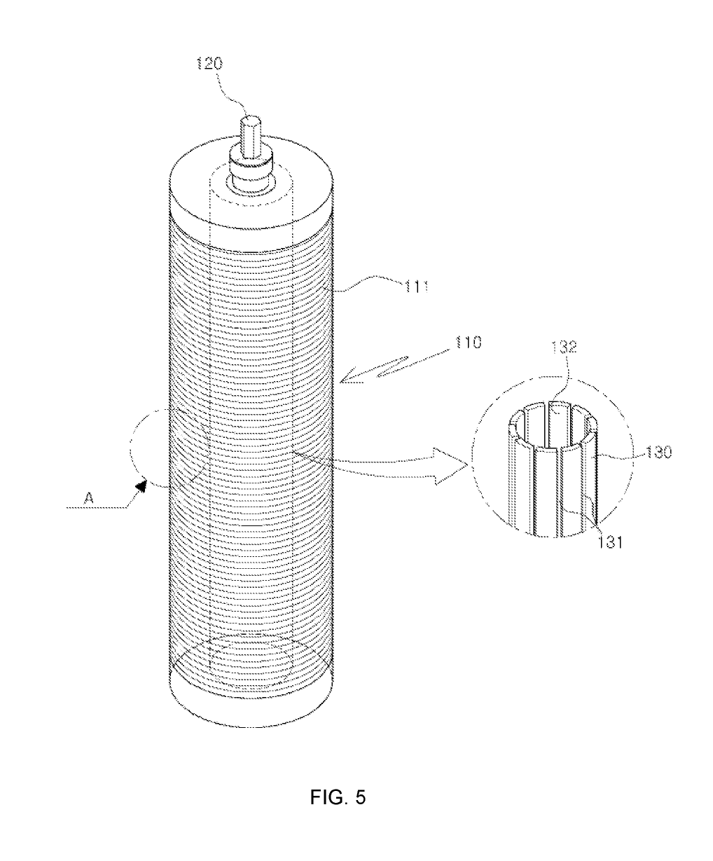

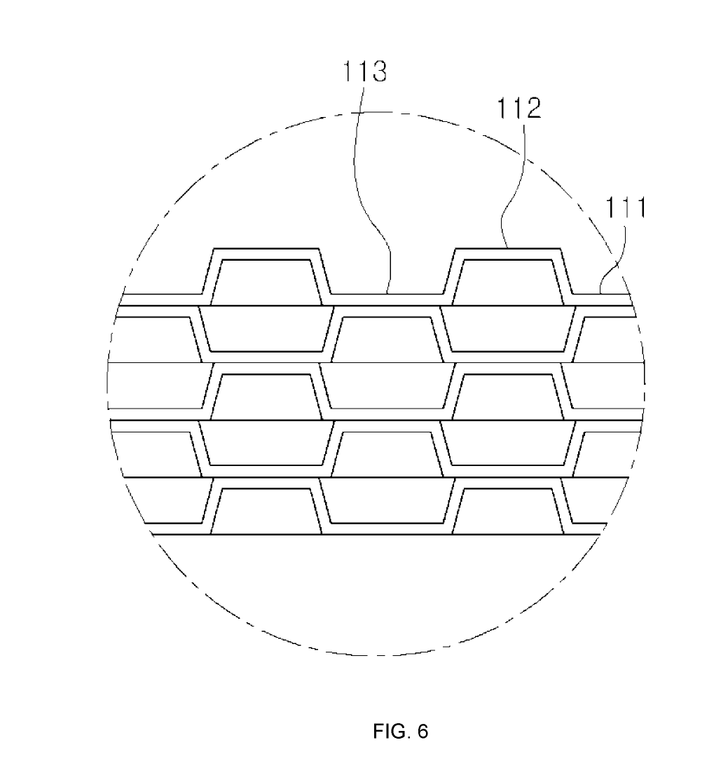

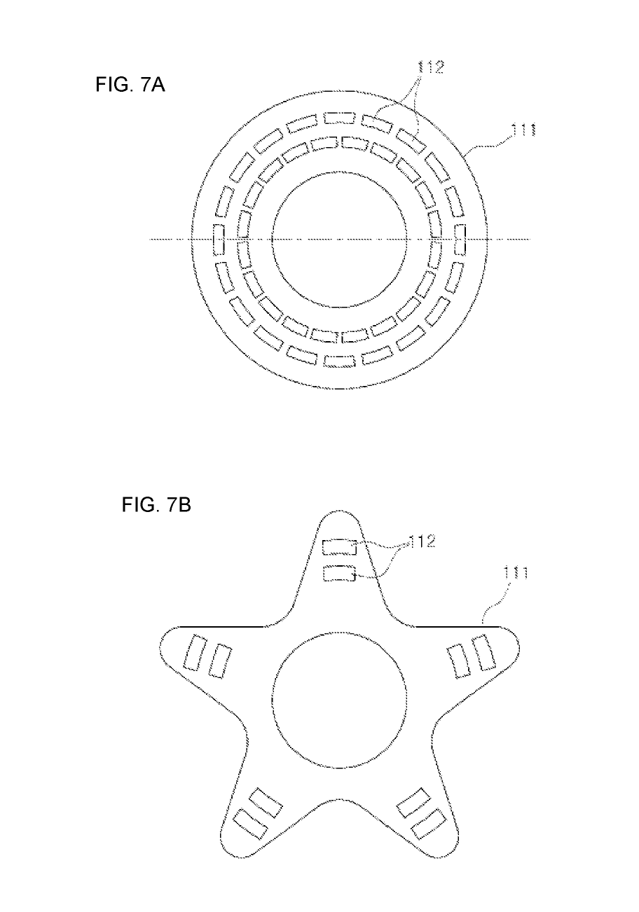

FIGS. 5 and 6 are views of an example of the filter unit which is applied to the embodiment of the present invention. FIGS. 7A and 7B show an example of the plate filter forming the filter unit.

The filter unit 110 may have an engaging portion 120 any one or all of top and bottom ends to engage with the base plates 210 and 220. The filter unit 110 has a column 130 with a plurality of inlet portions 131, through which the fluid passing the gap between the plate filters 111 flows in, and a hollow portion 132 in which the fluid passing the inlet portions 131 is staying, and the plate filters 111 are stacked along the column 130 on the surface.

As illustrated in FIG. 6, the plate filters 111 stacked along the column 130 respectively have a plurality of protrusions 112 and recesses 113 lower than the protrusions 112. The protrusion 112 or the recess 113 can be made in any shape. The fluid passes through the gap between the protrusions or the recesses of the plate filters 111 to remove the alien substances contained in the fluid.

FIGS. 5 to 7 show a typical example of the filter unit which can be applied to the present invention, but the present invention is not limited thereto. The present invention may include stacked-disc filter units or stacked-plate filter units which are widely known in the field.

The free-fraction filtration device according to the present invention can select any one of various operation methods in the filtering and cleaning processes.

Typically, the fluid to be filtered flows through the inlet port 270, and is discharged from the outlet port 280, during normal operation.

The cleaning operation can be executed depending upon the normal operating mode. In this instance, the cleaning water is introduced through the inlet port 270, and is discharged from a valve nozzle 290 through the filter unit 110. According to this operating mode, the valve of the outlet port 280 is closed, while the valve nozzle 290 is opened to discharge the used cleaning water.

During the backwash, the cleaning water can be introduced through the outlet port 280, and then the used cleaning water used for the filter unit 110 can be discharged from the valve nozzle 290.

The filtering operation mode and the cleaning operation mode can be properly selected according to a pollution source, pollutants, cleaning conditions, or the like.

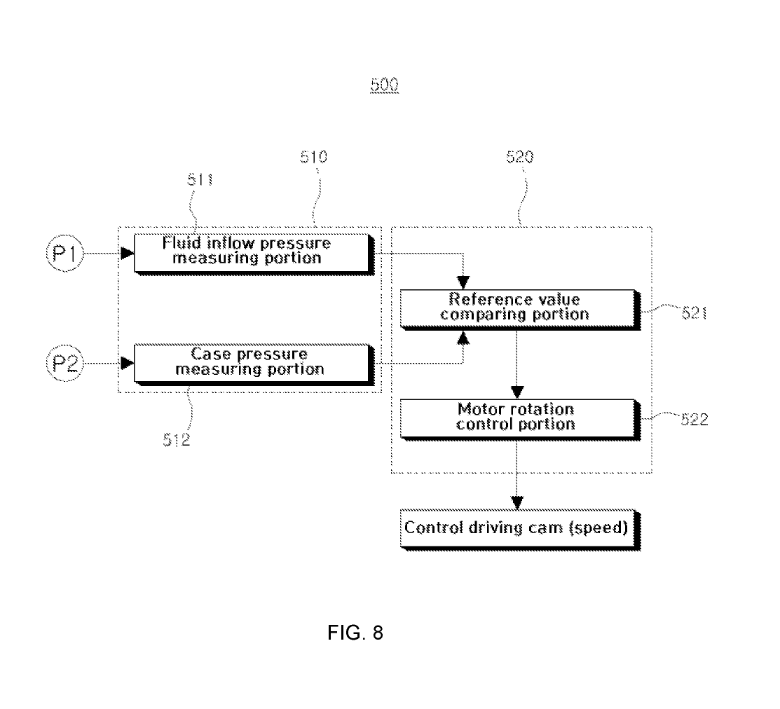

FIG. 8 is a block diagram of a control unit provided in the free-fraction filtration device according to the embodiment of the present invention.

The free-fraction filtration device according to the embodiment of the present invention will now be described in detail with reference to FIGS. 1 to 4 and FIG. 8.

The top plate 210 is pressed by the operating unit 400 in the case 200. A vibration plate 230 is interposed between the top plate 210 and the operating unit 400. A spring 300a is interposed between the vibration plate 230 and the top plate 210.

A guide pin 231 protrudes from a center of the vibration plate 230, and is moved up and down together with the top plate 210.

The bottom plate 220 located at the lower portion is resiliently supported by a spring 300b in a space t1 of the case 200.

The operating unit 400 may include a driving motor 410, a shaft 430 of the driving motor 410, the driving cam 420, and the vibration plate 230 which is brought into contact with the driving cam 420.

The driving motor 410 may have a control unit 500 which is controlled by measuring the pressure of the fluid.

The control unit 500 may include a measuring member 510 having a fluid inflow pressure measuring portion 511 to measure the inflow pressure of the fluid and a case pressure measuring portion 512 to measure the internal pressure of the case, and a controller 520 having a reference value comparing portion 521 to compare the pressure measured by the measuring member 510 and a preset reference value of the pressure and a motor rotation control portion 522 to control rotation of the driving motor 410.

Supposing that the measured internal pressure of the case is P2 and the reference value of the pressure is P, the control unit 500 can drive the driving motor 410 restrictively. Also, the control unit 500 can increase the speed of the driving motor 410. If the speed of the driving motor 410 is increased, the driving cam 420 is also increased to increase intensity of the vibration to be transmitted to the vibration plate. Since the control unit can properly control the operation according to fluctuations in the pressure of the fluid by stopping the operation or reducing the speed under other conditions.

The operation of the free-fraction filtration device constructed to filter the fluid according to the embodiment of the present invention will now be described.

As illustrated in FIG. 1, the fluid to be filtered is introduced into the case 200 through the inlet port 270.

The plurality of filter units 110 are circumferentially arranged along the top and bottom plates 210 and 220 in the case 200, and the fluid passes through the filter units 110. The filter unit 110 removes the alien substances lager than the interval of the gap between the stacked plate filters 111, while only the fluid passing the gap is discharged from the outlet port 280.

The alien substances caught by the gap between the stacked plate filters 111 of the filter unit 110 are stayed intact. In this instance, if the operating unit 400 operates, the alien substances caught by the gap between the plate filters 111 can be released therefrom.

The operating unit 400 includes the driving motor 410 and the shaft 430, and the operating cam 420 is mounted onto the shaft 430. The operating cam 420 rotates around the shaft 430 to form a top dead point and a bottom dead point, and thus the vibration plate 230 which is brought into contact with the operating cam vibrates according to the rotation position thereof.

Since the vibration plate 230 is supported by the spring 300a, the vibration plate is always brought into close contact with the operating cam 420, and when the operating cam 420 is rotated by the driving motor 410, the vibration plate 230 is vibrated due to deviation between the top and bottom dead points according to the position.

Since the vibration intensity of the vibration plate 230 is increased or reduced depending upon the rotation speed of the operating cam 420, the vibration intensity can be properly controlled by increasing or reducing the speed of the driving motor 410.

The vibration of the vibration plate 230 is continuously transmitted to the top plate 210, on which the filter units 110 are circumferentially arranged, through the spring 300a. The vibration continuously transmitted to the top plate 210 is also simultaneously transmitted to the bottom plate 220 supporting the lower portions of the filter units 110. In this instance, the spring 300b supporting the bottom plate 220 reduces vibration noises, and also supports the bottom plate 200 in an upward direction by the resilience. Compressing and restoring moments depend on the rotation position of the operating cam 420 around the shaft.

Accordingly, when the operating cam 420 is rotated by the operation of the driving motor 410, the vibration is transmitted to the top and bottom plates 210 and 220 supporting the filter units 110 at the top and bottom portions thereof, and thus the filter units 110 are vibrated in the vertical direction in the case 200 by the transmitted vibration. The vibration causes the alien substances caught between the plate filters 111 of the filter units 110 to move, thereby preventing the filter from being blocked due to the alien substances.

The alien substances caught by the filter units 110 can be properly removed by applying a power to the driving motor 410, if necessary.

The driving motor 410 of the operating unit 400 is controlled by the control unit 500 which is controlled by measuring the pressure of the fluid, thereby controlling the automatic operation of the free-fraction filtration device.

As illustrated in FIG. 8, the control unit 500 may include the measuring member 510 having the fluid inflow pressure measuring portion 511 to measure the inflow pressure of the fluid and the case pressure measuring portion 512 to measure the internal pressure of the case, and the controller 520 having the reference value comparing portion 521 to compare the pressure measured by the measuring member 510 and the preset reference value of the pressure and the motor rotation control portion 522 to control the rotation of the driving motor 410.

The measuring member 510 is a kind of sensor for measuring the pressure of the fluid and transferring a signal indicative of the measured pressure to the controller 520.

If the pressure P1 of the fluid introduced through the inlet port 270 is measured, the pressure of the fluid to be introduced through the inlet port 270 can be figured out. The fluid inflow pressure P1 is compared with the internal pressure P2 of the case or the reference value of the pressure P, and the driving condition of the driving unit can be determined depending upon the compared result.

If the internal pressure P2 of the case is measured, it is possible to determine whether there is a difference between the internal pressure P and the preset reference value P of the pressure.

If the internal pressure P2 of the case is compared with and is higher than the reference value P of the pressure, it is determined that the fluid passing through the filter units 110 is blocked by the alien substances and thus the internal pressure is increased. Accordingly, the driving motor 410 of the operating unit 400 operates. The operation of the driving motor 410 causes the driving cam 420 to rotate, thereby increasing the intensity of the vibration against the filter units 110 and thus removing the alien substances away from the filter unit 110 with the strong vibration. The rotation speed of the driving motor 410 can be properly adjusted depending upon the ratio of the internal pressure of the case, and thus can adjust the intensity of the vibration to remove the alien substances.

Herein, the internal pressure P2 of the case may be the pressure of the fluid passing the inside of the case or the pressure of the respective filter units 110.

In any cases, the pressure of the fluid introduced into the case can be measured by the sensor. If the flow rate of the fluid introduced into the case is higher than the preset reference value of the pressure, the controller determines that the filter has an unusual problem, such as blocked filter, and drives the driving motor 410 through the motor rotation control portion 522 to transmit the vibration to the filter units 110, as well as increasing the speed of the driving motor to increase the intensity of the vibration.

On the contrary, if the internal pressure P2 of the case is lower than the reference value P of the pressure, the control units determines that the flow rate is normal, and pauses the operation of the driving motor 410 in a standby mode.

Therefore, the present invention can automatically determine the unusual symptom caused by the blocked filters, and can selectively drive the driving motor 410 of the operating unit 400, when the filters are blocked. Also, the present invention can adjust the intensity of the vibration caused by the operating cam 420 to prepare the blockage of the filter.

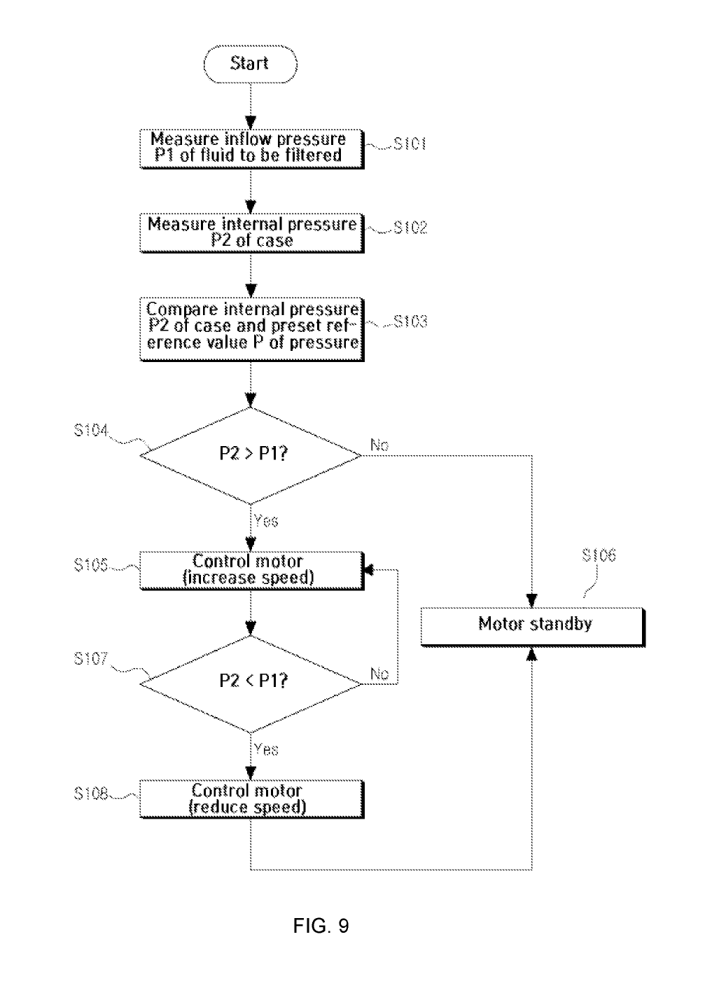

FIG. 9 is a flow chart illustrating an example of controlling the free-fraction filtration device according to the embodiment of the present invention.

According to the method of controlling the free-fraction filtration device, referring to FIG. 9, the inflow pressure P1 of the fluid introduced into the case is measured (S101). The inflow pressure is a pressure of the fluid introduced through the inlet port, and is not preset or specified.

The inflow pressure P1 of the fluid is information which is input in the controller 520 to be compared with the preset reference value of the pressure to determine the fluctuations in pressure.

Apart from the measurement of the inflow pressure of the fluid, the internal pressure P2 of the case which is the pressure of the fluid flowing in the case is measured (S102). Herein, the internal pressure P2 means a pressure in the case or the filter unit, which will be hereinafter referred to as the internal pressure of the case.

The internal pressure P2 of the case is information which is input in the controller 520 and compared with the preset reference value P of the pressure to determine the fluctuations in pressure and thus determine the blocked state of the filters.

After the inflow pressure of the pressure and the internal pressure of the case are measured, the reference value comparing portion 521 of the controller 520 compares the internal pressure P2 of the case and the preset reference value P of the pressure (S103).

If the internal pressure P2 of the case is higher than the preset reference value P of the pressure (S104), the driving motor 410 operates or the speed of the driving motor 410 is increased to rotate the driving cam 420 (S105). Otherwise, the driving power of the driving motor 410 is turned off to maintain in a standby mode (S106).

After that, if the controller 520 compares the internal pressure P2 of the case and the preset reference value P of the pressure and determines that the internal pressure P2 of the case is lower than the preset reference value P of the pressure (S107), the driving motor 410 for rotating the driving cam 410 is stopped or the speed of the driving motor 410 is reduced (S108). After the reduction, the driving power of the driving motor 410 is turned off to maintain in the standby mode.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A free-traction filtration device comprising:
a plurality of filter units each consisting of some sheets of stacked plate filters, in which alien substances caught between the stacked plate filters are removed away from the plate filters by vibration of a vibration plate;
a cylindrical case in which the plurality of filter units are installed;
top and bottom plates configured to support the filter units at upper and lower portions thereof so as to determine and maintain positions of the filter units, the filter units being circumferentially arranged between the top and bottom plates;
a spring configured to resiliently support the top and/or bottom plates in a horizontal state;
an operating unit configured to transmit vibration to the filter units arranged between the top and bottom plates; and
a vibration plate configured to be resiliently supported by the spring between the top or bottom plate and the operating unit, the top or bottom plate being pressed by the operating unit in the case.

2. The free-traction filtration device according to claim 1, wherein the vibration plate includes a guide pin protruding from a center thereof, and the guide pin is moved up and down by the top or bottom plate.

3. The free-traction filtration device according to claim 1, wherein the top or bottom plate is resiliently supported by the spring in an inside of the case.

4. The free-traction filtration device according to claim 1, wherein the operating unit includes a driving motor, a shaft extending from the driving motor, and a driving cam installed on the shaft, the vibration plate being into contact with the driving cam.

5. The free-traction filtration device according to claim 1, wherein the driving motor includes a driving motor, and the driving motor has a control unit which is controlled by measuring a pressure of the fluid.

6. The free-traction filtration device according to claim 5, wherein the control unit has a measuring member having a fluid inflow pressure measuring portion to measure an inflow pressure of the fluid and a case pressure measuring portion to measure an internal pressure of the case; and a controller having a reference value comparing portion to compare the inflow pressure measured by the measuring member and a preset reference value of the pressure and a motor rotation control portion to control rotation of the driving motor.

7. The free-traction filtration device according to claim 6, wherein if the measured internal pressure P2 of the case is higher than the reference value P of the pressure, the control unit drives the driving motor or increases rotation speed of the driving motor.

8. A method of controlling the free-fraction filtration device according to claim 1, the method comprising the steps of:
measuring an inflow pressure of a fluid introduced into a case by a measuring member, in which a plurality of filter units are circumferentially arranged in the case;
measuring an internal pressure of the case by a measuring member, and comparing the measured values and a reference value of the pressure by a controller of a control unit; and
if the internal pressure of the case is higher than the preset reference value of the pressure, operating a driving motor, which rotates a driving cam, to transmit vibration to the filter units through the driving cam, and if the internal pressure of the case is lower than the preset reference value of the pressure, stopping the driving motor to stop operation of the driving cam.

9. The method of controlling the free-traction filtration device according to claim 8, further comprising, if the measured internal pressure P2 of the case is lower than the reference value P of the pressure, pausing the operation of the driving motor in a standby mode.
